(19) United States
(12) Patent Application Publication
(10) Pub. No.: US 2023/0337590 A1
(43) Pub. Date: Oct. 26, 2023

(54) Pole Engageable Power Saw and Method of Employment Thereof

(71) Applicant: Gary Waggener, Harrisburg, OR (US)

(72) Inventor: Gary Waggener, Harrisburg, OR (US)

(21) Appl. No.: 18/137,344

(22) Filed: Apr. 20, 2023

Related U.S. Application Data
(60) Provisional application No. 63/332,911, filed on Apr. 20, 2022.

(51) Int. Cl. A01G 3/08; B25F 5/02; H04N 7/18

(52) U.S. Cl. CPC A01G 3/086; B25F 5/02; H04N 7/185

(57) ABSTRACT

A power saw system having an electric power saw in a varying angled engagement to a pole is provided. The pole is extendable to position the power saw elevated for cutting branches and the like. A remote control, actuated by a user, connects electric power to the saw to cause the saw blade to cut. A camera may be included to provide a remote user a view of the saw blade and areas proximal to it.

### BACKGROUND OF THE INVENTION

### 1. Field of the Invention

This application claims priority to U.S. Provisional Pat. Application serial number 63/332,911 filed on Apr. 20, 2022, which is incorporated herein in its entirety by this reference thereto.

The invention herein disclosed relates generally to insulated poles widely known as “hot sticks” or “long sticks” conventionally employed for servicing power grids. More particularly, it relates to a device and method for the engagement and operation of electrically powered saws to the distal ends of such insulated poles.

### 2. PRIOR ART

### Background of the Invention

In the electric power distribution industry, where electric power grids provide electric power to homes and industry, a widely employed tool in the service and repair of locations on such a power grid is an insulated pole also known as a “long stick” or a “hot stick.” Such insulated poles are, conventionally, formed of a dielectric material which will not conduct electricity. This is because they are frequently employed by workers in the industry, who are positioned on the ground or in a grounded location to service the energized electric lines and circuits.

While originally formed of wood, modernly, such insulated poles are formed of fiberglass or a polymeric material which will not conduct electricity. In this fashion, when such an insulated pole is employed to position the distal end thereof in the proximity of an energized electric power line, the worker holding the proximal end is protected from electrical shock should the pole or a tool engaged therewith make contact with the power line.

A popular form for such insulated poles is the formation thereof in a telescopic configuration. In this mode of such insulated poles, it may be extended in increments wherein each extended section will removably lock in an engagement with an adjacent telescopic section of the insulated poles. Once an overall length of the telescopic insulated pole is achieved, the user can employ the distal end thereof or a tool engaged to the distal end to perform maintenance or other work. Such, for example, can include the switching or circuit breakers or the positioning of insulators or many other conventional functions where the worker must be protected from the electrical grid.

In this fashion, the insulated pole not only electrically insulates the worker from the energized conductor, it provides physical separation from the device being operated, to reduce the chances of burns which might result from electrical arcing if there is a malfunction of the device being operated.

With respect to the above, before explaining at least one preferred embodiment of the pole engageable power saw and method thereof herein, it is to be understood that the disclosed pole engageable device and system are not limited in application to the details of employment and to the arrangement of the components or the steps set forth in the following description or illustrated in the drawings. The various apparatus and operations of the herein disclosed system for pole engagement and use of a powered saw herein are capable of other embodiments, and of being practiced and carried out in various ways, all of which will be obvious to those skilled in the art once the information herein is reviewed.

Also, it is to be understood that the phraseology and terminology employed herein are for the purpose of description, and should not be regarded as limiting. As such, those skilled in the art will appreciate that the conception upon which this disclosure is based, may readily be utilized as a basis for other insulated pole engagement systems which provide for the connection and use of powered saws, for workers servicing power lines. It is important, therefore, that the embodiments, objects and claims herein, be regarded as including such equivalent construction and methodology insofar as they do not depart from the spirit and scope of the present invention.

### SUMMARY OF THE INVENTION

The disclosed device herein provides a system and method for the easy removable engagement of an electric powered saw at the distal end of an insulated and preferably telescopic pole. So positioned, the user holding the pole may raise the distal end to position an engaged saw at a working position wherein it is operatively positioned for cutting a branch or the like.

With the saw substantially in the cutting position, activation of a wireless remote control by the user will communicate an electronic signal to an actuator to cause the actuator to change from a disconnected state where electric power is not communicated to the motor, to a connected state where electric power from a battery or power source is connect to the motor to power it to rotate. A wireless camera mounted adjacent the saw cutting blade and light can be included. Such will allow the user to view the saw cutting blade in position adjacent branches and the like, which are intended to be cut by the saw cutting blade.

The communicated picture from the camera to a display screen, either on a remote control or a computing device such as a tablet or smart phone, can, thus, be employed to properly position the saw cutting blade relative to the intended branch to be cut. This is especially helpful where the user is many feet from the cutting position or where branches and the like obscure the view thereof. In a dim light situation, such as cutting at night or in a shaded area, a lighting component or light emitter can illuminate both the saw cutting blade and areas adjacent it to allow the user to employ the saw at night or in dim light and properly position the saw cutting blade relative to the branch or the like being cut.

The system, in one preferred mode, can be provided where new saws have a saw housing adapted with one or a plurality of mounts configured for engaging the housing to a pole. In an alternative mode of the system, a secondary housing may be provided, which is configured to engage with the exterior of an existing battery powered saw. Once engaged thereto, a mount on the secondary housing is configured for a fixed angled connection to the distal end of the insulated pole using a connector having removably fixable angled positions.

Additionally preferred is the provision of a hook component which is either formed as part of a housing surrounding the chain saw, or more preferably, formed to allow for replacing and flipping the hook directly is engageable to a mount on the housing for the connection to the pole. Where such housings or surrounding housings are formed of polymeric material to minimize weight, the hook component may be provided as a separate but engageable hook component. Such allows for replacement and for imparting the force on the hook, when pulled by the pole, to the pole and not to the housing. Fasteners, such as screws with nuts or other cooperating fasteners, are employed to engage the hook component to a bottom or top mount on the edge of the housing for the saw.

This hook component is especially preferred in that it may be employed to pull on branches and such prior to, or especially after, cutting has occurred. It was found, in experimentation with multiple versions of the device herein, that the hook component provided valuable utility in that the curved area thereof can be placed in contact with curved branches to pull them out of the way or to pull them apart, so they fall, once cut. Forming the hook component of metal or exceptionally strong non metallic material, such as carbon fiber, is preferred as is making it removably engageable, so that the hook can handle all the force required to pull on branches using the pole without deforming and eliminate any force imparted to the housing.

With respect to the above description, before explaining at least one preferred embodiment for engagement and use of a powered saw on an insulated pole herein, it is to be understood that the invention is not limited in its application to the details of operation nor the arrangement of the components or the steps set forth in the following description or illustrations in the drawings. The various methods of implementation and operation of the communication system herein are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis for designing of other saw engagement an operation for insulated poles and for carrying out the several purposes of the disclosed communication system. Therefore, the objects and claims herein should be regarded as including such equivalent construction, steps, and methodology insofar as they do not depart from the spirit and scope of the present invention.

It is an object of this invention to provide an apparatus for the engagement of a powered electric saw which may be remotely actuated to angled engagements to an insulated pole.

It is a further object of this invention to provide such a system for positioning a remotely actuated powered saw on an insulated pole or non-conductive pole, which may be used to mount conventional battery powered saws to such insulated poles or which may be employed for newly manufactured battery powered saws to configure them for engagement to an insulated pole.

Another object of this invention is the provision of a battery powered saw with remote actuation which also includes a wireless camera to view the area of the saw which will be or is contacting the surface to be cut.

These, together with other objects and advantages which become subsequently apparent, reside in the details of the construction and operation of the pole engaged electric powered saw and engagement system and method herein as more fully hereinafter described and claimed, reference being had to the accompanying drawings forming a part thereof, wherein like numerals refer to like parts throughout.

Further objectives of this invention will be ascertained by those skilled in the art as brought out in the following part of the specification wherein detailed description is for the purpose of fully disclosing the invention without placing limitations thereon.

### BRIEF DESCRIPTION OF DRAWING FIGURE

The accompanying drawings, which are incorporated herein and form a part of the specification, illustrate some, but not the only or exclusive examples of embodiments and/or features of the electric saw mounting system and method for insulated poles herein. It is intended that the embodiments and figures disclosed herein are to be considered illustrative of the invention herein, rather than limiting in any fashion.

In the drawings:

FIG. 1 depicts a view of the components of the system herein showing a battery powered chainsaw having a housing or engaged housing and a hook component which are configured for a removable connection to the distal end of an insulated pole and an optional camera and viewing screen employable along with the remote control thereof and showing the hook engaged with the pole mount and housing.

FIG. 2 depicts one preferred mode of removable engagement of the edge of the electric powered saw having a hook formed as part thereof or engaged thereto to the distal end of an insulated pole which allows for radial adjustment and resulting adjustment of the angle of the saw cutting blade along with an engageable hook component.

FIG. 3 shows a mode of the device herein having an engageable secondary housing configured to employ existing electric saws where the secondary housing has an interior cavity with contours which are complimentary to the exterior surface of a saw housing to be used herewith and also showing a trigger interface for the remote control to cause a wireless signal to be transmitted to actuate the powered saw.

FIG. 4 shows an especially preferred mode of the device herein, in a sectional view, showing the internal components which operate to receive a wireless signal to actuate the saw and showing dual top and bottom mounts to engage a pole at a fixed angle and which are also engageable to hook components, such as in FIG. 4 or FIG. 5.

FIG. 5 depicts another preferred device, as in FIG. 4, also showing a sectional view through the exterior casing and showing a first mount positioned on a bottom edge of the housing and second mount positioned on an opposite top edge of the housing. Both being engageable to a removable hook component which provides the radially adjustable connection to a pole mount connector.

### DETAILED DESCRIPTION OF THE PREFERRED

### Embodiments of the Invention

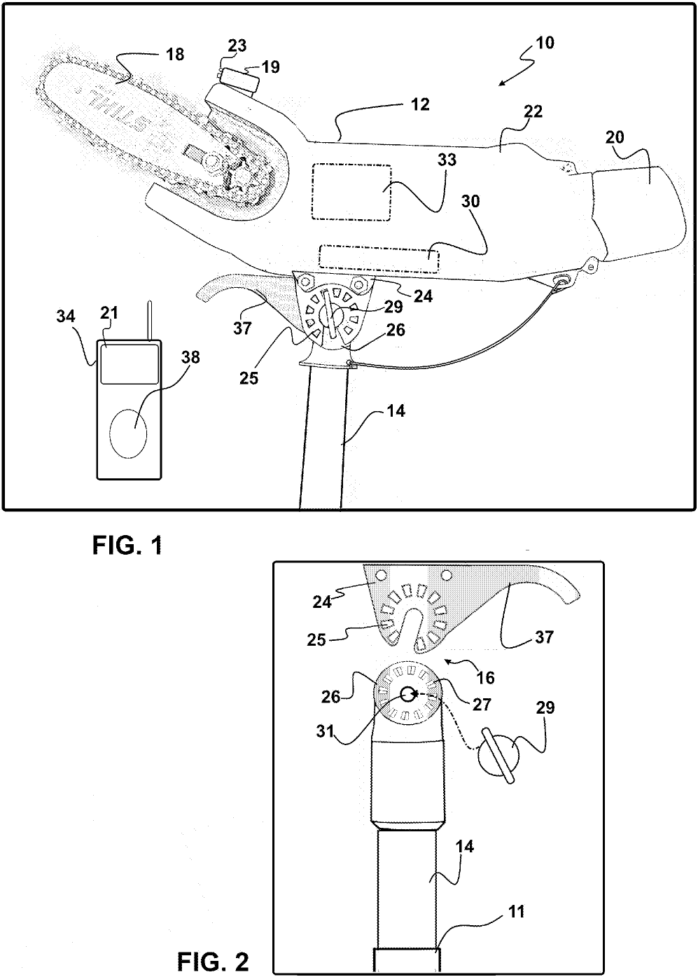

Referring now to the system 10 herein in the depictions of FIGS. 1-5, there is seen in FIG. 1 an exemplar of the components of the system 10 herein. As shown, a battery powered saw 12 is operatively engaged to a distal end of an insulated pole 14 which is preferably telescopic in configuration. The pole 14 need not be part of the system 10 herein, and the saw 12 may be provided in a configuration adapted to removably engage to the distal end of a conventional insulated pole 14. However, the pole 14 must be configured to removably engage to a mount connected to the housing of the saw and is, preferably, radially configured so the angle between the two may be changed and fixed, as needed.

The removable engagement 16 (FIG. 2), preferably, provides for an angular adjustment of the saw 12 relative to the axis of the pole 14. By angular adjustment is meant that an angle of the saw cutting blade 18 of the saw can be fixed when the saw 12 is in a removable engagement 16 to the pole 14 but can be changed to another angle by changing the position of the pole mount 26 in its engagement with the mount 24 engaged to or projecting from the housing 22 of the saw.

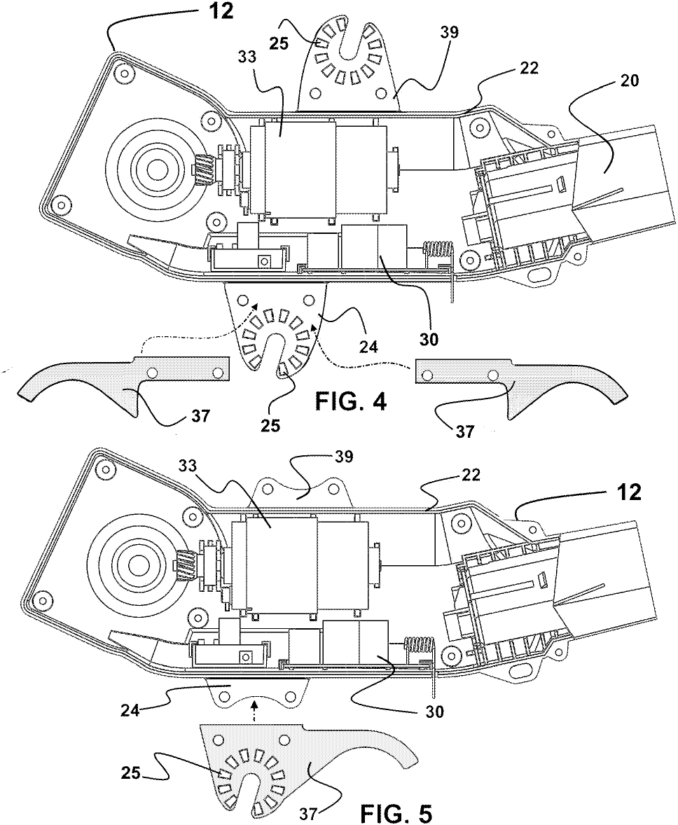

The mount 26, shown in FIG. 1, may include the plurality of radially positioned openings 25, such as in FIG. 4, or may be configured, such as in FIG. 5, wherein a component, such as the hook component 37, is engaged to the mount 24 or 39 to provide the radially positioned openings to engage over the projections 27 extending from the pole mount 26. Of course, the projections 27 and openings 25 may be reversed in position or replaced with other connections which will provide the formation of an adjustable fixed angled connection between the saw and the pole 14.

By adjustable fixed angled connection is meant that the pole engagement to the housing 22 of the saw will form a fixed angle of the axis of the saw cutting blade 18 relative to the axis of the pole 14, which holds under force but which can be changed by repositioning the connection engaged to the housing 22 and the pole mount 26 connection. As noted, radially positioned projections 27, which will slide into complimentary spaced radially positioned openings 25, provide the current preferred adjustable fixed angled connection.

As shown in FIG. 1, the saw 12 has an electric power source in the form of a removable battery 20 which is engageable with the housing 22 holding the battery powered saw blade 18. It is preferred that this battery 20 can be removed and replaced without disengaging the saw 12 from the pole 14.

Also shown in FIG. 1 are a video camera 19 which will wirelessly communicate a video view of the saw cutting blade 18 and areas adjacent it to a remote display 21 which may be mounted at the grasping end of the pole 14 or on the remote control 34. The camera 19 and display 21, if provided, will allow the user to view and position the saw cutting blade 18 properly, relative to a branch or the like being cut which would also be viewable in the display 21 from the ground, remotely. Touching an activation control button 38 will cause the remote control 34 to transmit a wireless signal to the actuator 30 causing it to change to the connected state, where electric power from the battery 20 is connected to the motor 33 to thereby cause the saw blade 18 to move and cut.

Optionally, the remote control 34 and display 21 could be a smartphone which has wireless capability and software operating to the task of communicating a wireless signal to the actuator 30 which causes it to change from the disconnected state to a connected state which connects electric power from the battery 20 to the motor 33 to move the saw blade 18 to cut. If a smartphone is used, an app will interface with the remote actuator 30 to allow the user to employ the display screen and/or keypad on the smartphone to control the saw and to view video from the camera 19. A light 23 may be included with the camera 19 to illuminate both the saw cutting blade 18 and area around it.

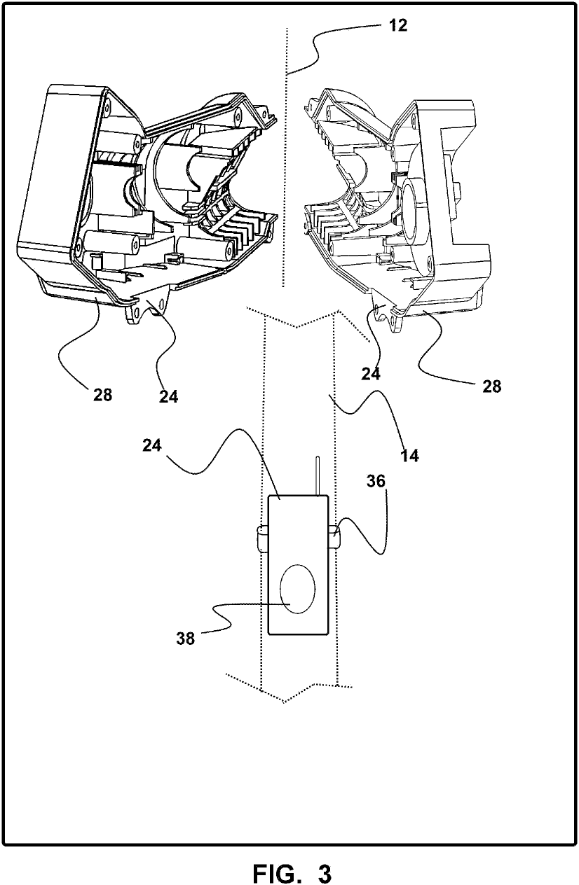

In all modes of the system 10, a remote actuator 30 is operatively positioned in or with the housing 22, as shown in FIGS. 3-4, which operates upon receiving a wireless transmission to switch and communicate electric power from the battery 20 to the motor 33 powering the cutting blade of the saw 12. The remote actuator 30 has an antenna and circuitry which is activated by the wireless signal from a remote control 34. Upon receipt of a signal, the actuator 30 will cause power from the battery 20 to connect with the motor 33, thereby causing the saw to cut. Particularly preferred is a wireless remote control 34 which is configured for an engagement to the pole 14 at a position on the end held by the user. This allows the employment of both hands of the user to manipulate the pole 14 while still being able actuate the saw as needed.

As shown in FIG. 3 but applicable to all modes of the device 10 herein, a connector 36 is preferably engaged on the remote control 34 which will hold it operatively engaged upon the pole 14. Such may be a clip or clamp or other conventional connector 36 which will hold the remote control 34 in place on the pole 14, whereby the user may operate the activation button 38 which will activate the remote control 34 to send a wireless signal to the actuator 30 to cause it to switch and to connect the battery 20 operatively to the motor 33 to energize the saw 12 and cause the saw cutting blade 18 to move under power of the electric motor 33. The saw blade 18, thus, has a cutting mode or operation wherein the cutting blade 18 moves or reciprocates when powered by the electric motor 33. The cutting blade 18, currently preferred, is a chainsaw type cutting blade 18 as it will quickly cut through branches and the like. However, it could also be a reciprocating blade.

In FIG. 2 is shown an enlarged view of a preferred mode of removable engagement 16 of the housing 22 of the saw to the pole 14, as noted above. As shown, one of the housing mount 24 or pole mount 26 has the radially positioned openings 25 in it. The pole mount 26, engaged to the distal end of the pole 14, will have projections 27 thereon which are radially positioned to align with and engage with the radially positioned openings 25. Once the openings 25 are positioned over the projections 27, a nut 29 or the like can be engaged upon a center mount, such as a threaded member 31, to hold the housing mount 24 and housing in the chosen fixed angled engagement with the pole 14. Because the openings 25 radially align with the projections 27, rotation of the component with the openings 25, during engagement to the projections 27, allows for a change in the fixed angle of the housing 22 and the saw cutting blade 18 relative to the axis of the pole 14. As noted herein, the projections 27 and openings 25 may be reversed as to placement where the openings are on the pole mount 26 and the projections 27 are on the mount 24.

As also noted, the housing 22 of a the saw 12 can be configured such that it has a projecting housing mount 24 which is configured for removable engagement to a pole mount 26 located at the distal end of a pole 12. The projecting housing mount 24 may include a hook component 37 or in the preferred mode of the device, the hook component 37 is removably engageable to the formed housing mount 24 which allows for replacement and a flipping of the hook component 37 to place it toward the front or the rear of the saw.

In modes of the device where a first mount 24 is located on the lower edge and a second mount 39 projects from a top or upper edge of the housing 22 opposite the lower edge, the removably engageable hook 37 is especially preferred in that it may be repositioned, as may the housing 22, to place the saw cutting blade 18 at an inclining or declining angle depending on which of the first mount 24 or second mount 39 is used to engage the pole 14 in the fixed angled mount.

Alternatively, as depicted, for example in FIG. 3, the system 10 can also be provided with a secondary housing 28 to allow the use of an existing saw. This secondary housing 28 may be formed of non conductive material and sized and contoured to surround and engage with the exterior of an existing saw housing 22 of an existing electric saw. In this mode, the secondary housing 28 would be provided with an interior or other surface configuration which is complimentary to the exterior mating surface of the housing 28 of an existing saw. The secondary housing 28 will be connected to an existing saw, and then the mount 24, positioned on the secondary housing 28, will be engaged with the complimentary pole mount 26 of the chosen insulated pole 14. The mount 24 on the secondary housing 28 is preferably configured to engage with a hook component 37, also.

In this mode of the system 10, a plurality of different secondary housings 28 can be provided with each of the plurality configured for operative engagement to the exterior of a specific existing powered saw. This mode of the system 10 is adapted for employment for users already owning electric saws. The secondary housing 28, preferably, once operatively connected to a saw, will provide for insertion of a battery 20 on the existing saw or secondary housing 28 without the need to remove the pole 14.

Shown in FIG. 4 is an especially preferred mode of the device 10 herein in a sectional view of the housing 22 and showing the internal components which operate and actuate the motor and saw. Also shown are a first housing mount 24 and second housing mount 39. Both of which are configured with radial openings for a varying angled engagement with the pole mount 26 engaged to the pole 14. Hook components 37, such as in FIG. 5, are engageable to either the first mount 24 or second or upper mount 39 so that the hook component 37 may be included in a mount of the pole 14 to either the upper or lower edge of the housing 22.

In FIG. 5 is shown another preferred device 10 showing a sectional view and the exterior of the casing 22 and showing a first or lower housing mount 24 positioned on a bottom edge of the housing 22 and second mount 39 positioned on an opposite top edge of the housing 22. Both of the mounts are configured for engagement to a hook component 37 which also has the mating openings 25 or projections 27 thereon to allow for engaging the pole 14 to the housing 22 at varying angles which are held fixed by the openings engaged to the projections, as noted above. Other mounts may be employed if they provide for changing the angle of the housing 22 relative to the axis of the pole 14, so long as such mounts will strongly hold at a chosen angle.

The hook components 27 are also removably engageable so they may be replaced and may be flipped in position between a forward located position, as in FIG. 1, and a rearward position with the hook extending toward the battery 20, as in FIG. 2.

In a method of the system 10 herein, a user will removably engage the mount 24 located on a housing 22 of a saw 12 or upon a secondary housing 28 engaged to a housing 22 of a saw to a pole mount 26 at the distal end of an insulated pole 14. The angle of the axis of the saw cutting blade 18 can be adjusted during the engagement of the saw to the pole mount 26, as noted above. The hook component 37 will also be positioned in a forward or rearward positioning. A nut 29 or other engageable connector will be tightened to hold the mount 24 to the pole mount 26 at the chosen angle and to hold the hook component 37 to the housing 22 or to the pole connector. The user will then extend the pole 14, which has telescopic sections 11 (FIG. 2), to position the distal end of the pole 14 and the saw thereon at a work position. Once operatively positioned, the user will actuate the remote control 34 to energize the saw to cause the saw cutting blade 18 to cut the chosen branch or the like.

While all of the fundamental characteristics and features of the disclosed insulated pole electric saw engagement system and method have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions as would occur to those skilled in the art, are considered as included within the scope of the invention as defined by the following claims.

What is claimed is:

1. A power saw apparatus, comprising:
a saw having a housing surrounding an interior cavity;
a cutting blade extending from said housing, said cutting blade being connected to an electric motor engaged with said housing;
a pole having a first end for gripping by a user and having a second end;
a connection, said connection engaging said second end of said pole to a mount on said housing;
an actuator engaged between an electric power source and said electric motor, said actuator having a connected state communicating electric power to the electric motor and a disconnected state;
said motor moving said cutting blade with said actuator in said connected state;
a remote control, said remote control being user actuable to communicate a wireless signal to said actuator, said wireless signal changing said actuator to said connected state, whereby said motor is energized with electric power from said electric power source and moves said saw blade.

2. The power saw apparatus of claim 1 additionally comprising:
said connection of said second end of said pole to said mount on said housing is an adjustable fixed angled connection which positions an angle of an axis of the cutting blade in a fixed position relative to an axis of the pole.

3. The power saw apparatus of claim 1 additionally comprising:
a hook component, said hook component having a curved end opposite a second end thereof; and
said hook component removably engageable to said connection.

4. The power saw apparatus of claim 2 additionally comprising:
a hook component, said hook component having a curved end opposite a second end thereof; and
said hook component removably engageable to said connection.

5. The power saw apparatus of claim 3 additionally comprising:
said hook component removably engageable to said connection in a first position having said curved end extending in a first direction from said mount toward said cutting blade; and
said hook component removably engageable to said connection in a second position, having said curved end extending in an opposite direction from said first direction.

6. The power saw apparatus of claim 4 additionally comprising:
said hook component removably engageable to said connection in a first position having said curved end extending in a first direction from said mount toward said cutting blade; and
said hook component removably engageable to said connection in a second position, having said curved end extending in an opposite direction from said first direction.

7. The power saw apparatus of claim 1 additionally comprising:
a camera engaged to said housing, said camera wirelessly communicating a picture of said cutting blade to a remote display.

8. The power saw apparatus of claim 2 additionally comprising:
a camera engaged to said housing, said camera wirelessly communicating a picture of said cutting blade to a remote display.

9. The power saw apparatus of claim 3 additionally comprising:
a camera engaged to said housing, said camera wirelessly communicating a picture of said cutting blade to a remote display.

10. The power saw apparatus of claim 4 additionally comprising:
a camera engaged to said housing, said camera wirelessly communicating a picture of said cutting blade to a remote display.

11. The power saw apparatus of claim 2 additionally comprising:
said adjustable fixed angled connection being formed between a plurality of radially positioned projections on a first connector positioned on one of said pole or said housing, and a plurality of radially positioned openings positioned on a second connector positioned on the other of said pole or said housing.

12. The power saw apparatus of claim 4 additionally comprising:
said adjustable fixed angled connection being formed between a plurality of radially positioned projections on a first connector positioned on one of said pole or said housing, and a plurality of radially positioned openings positioned on a second connector positioned on the other of said pole or said housing.

13. The power saw apparatus of claim 6 additionally comprising:
said adjustable fixed angled connection being formed between a plurality of radially positioned projections on a first connector positioned on one of said pole or said housing, and a plurality of radially positioned openings positioned on a second connector positioned on the other of said pole or said housing.
